(19) United States
(12) Patent Application Publication
(10) Pub. No.: US 2006/0020726 A1
(43) Pub. Date: Jan. 26, 2006

(54) Controlling enablement and disablement of computing device component

(76) Inventors: Kazuo Fujii, Yokohama (JP); Takayuki Katoh, Yokohama (JP); Ken Sasaki, Yamato-shi (JP)

Correspondence Address: LAW OFFICES OF MICHAEL DRYJA, 704 228TH AVENUE NE, PMB 694, SAMMAMISH, WA, 98074, US

(21) Appl. No.: 10/899,206

(22) Filed: Jul. 25, 2004

(51) Int. Cl. G06F 13/00

(52) U.S. Cl. 710/100

(57) ABSTRACT

Controlling enablement and disablement of a computing device component, such as a wired or wireless network component of a portable computer, is disclosed. A circuit includes a switch, a flip-flop, and a multiplexer. The switch is situated on a select line of the component, between the component and a bus, and controls visibility of the select line at the bus, which determines whether the component is enabled or disabled. The flip-flop has an output that is connected to an input of the switch, and the multiplexer is connected to an input of the flip-flop. A first input of the multiplexer is connected to the output of the flip-flop, a second input is connected to a signal, and an enable line of the multiplexer determines whether the first or second input is sent to the flip-flop. The signal is set according to whether the component is to be enabled or disabled.

### FIELD OF THE INVENTION

The present invention relates generally to computing device components, such as wired and wireless network controllers or adapters for laptop or notebook computers, and more particularly to controlling the enablement and disablement of such components.

### BACKGROUND OF THE INVENTION

Wireless network connectivity has become popular, especially among laptop and notebook computer users. With wireless network connectivity, such as so-called 802.11a, 802.11b, or 802.11g wireless network connectivity, mobile computer users can access the Internet, and potentially the networks of their organizations, while remaining untethered to cords and wires. For instance, users who find themselves in airports and other places may be able to connect in “hot spots,” which are public areas in which wireless network connectivity can be accomplished, sometimes for a small fee.

Originally, laptop and notebook computer users had to insert special wireless network connectivity cards into their computers to obtain wireless network connectivity. Such cards are usually of a type known as PC Cards, which are insertable into corresponding PC Card slots found in most laptop and notebook computers. However, with the increasing demand from users for built-in wireless network connectivity, more, if not most, laptop and notebook computers now come with built-in wireless network connectivity. Therefore, users no longer have to purchase, install, and manage wireless network connectivity cards for their laptop and notebook computers.

However, laptop and notebook computers with built-in wireless network connectivity can cause problems for network and computer administrators of large organizations. Large organizations typically purchase a large number of laptop and notebook computers at a single time. To ensure that all of the computers are equally configured, network and computer administrators usually preload a custom image of an operating system and the necessary application computer programs onto the computers. However, such administrators have found that the inclusion of built-in wireless network connectivity within the laptop and notebook computers can cause problems with the custom image preloading process on these computers.

Therefore, network and computer administrators of large organizations in particular desire a way to temporarily disable the built-in wireless network connectivity of laptop and notebook computers, while they are preloading custom images to these computers. For desktop computers, the usual way to accomplish this is to set a device disable signal associated with built-in network connectivity through the basic input/output system (BIOS) of such computers, which disables the built-in network connectivity. Setting the device disable signal through the BIOS of desktop computers allows the administrators to temporarily disable built-in network connectivity, until after the custom image preloading process has been completed.

However, this approach does not necessarily work for portable computers like laptop and notebook computers. The device disable signal has to be guaranteed that it is active throughout a reset transition period of a computer. Because a desktop computer is assumed to be always connected to a power source, such as a wall outlet, this guarantee in the context of desktop computers is not a problem. However, laptop and notebook computers usually can operate off two different power sources: an internal, direct current (DC) battery, and an external, alternating current (AC) power source, such as a wall outlet. Where such portable computers are operating off a DC battery, shutting down the portable computers means that there is no auxiliary power to guarantee that the device disable signal remains active through reset transition periods of these computers.

Therefore, the approach employed to temporarily disable network connectivity in desktop computers is not suitable for use with portable computers like desktop and laptop computers. For this and other reasons, therefore, there is a need for the present invention.

### SUMMARY OF THE INVENTION

The present invention relates to controlling the enablement and disablement of a computing device component, such as a wired or a wireless network connectivity component of a portable computer, like a laptop or a notebook computer. A circuit of one embodiment of the invention includes a switch, a flip-flop, and a two-way multiplexer. The switch is situated on a select line of the computing device component, between the component and a bus, such as a Peripheral Component Interconnect (PCI) bus. The switch controls whether the select line of the component is visible at the bus. Visibility of the select line at the bus determines whether the component is enabled or disabled.

The flip-flop has an output that is connected to an input of the switch, whereas the two-way multiplexer is connected to an input of the flip-flop. A first input of the multiplexer is connected to the output of the flip-flop, and a second input of the multiplexer is connected to a controllable input/output signal. The multiplexer has an enable line that determines whether the first input or whether the second input is sent to the flip-flop. Therefore, the controllable input/output signal is set in accordance with whether the component of the computing device is to be enabled or disabled.

A computing device of an embodiment of the invention may be a portable computer, such as a laptop or a notebook computer, or another type of computing device. The computing device includes a component, such as a wired or a wireless network connectivity component, a bus, such as a PCI bus, and a circuit. The component has a select line, to which the bus is connected. The circuit is situated on the select line of the component, and is connected between the component and the bus to control visibility of the select line at the bus regardless of whether power is removed from the computing device, and regardless of whether the bus is inactive.

A method of an embodiment of the invention is for controlling enablement and disablement of a component of a computing device. A bus to which the component is connected is reset, where visibility of a select line of the component at the bus determines whether the component is enabled or disabled. A value stored in a non-volatile memory corresponding to whether the component should be enabled or disabled is read. The value of a controllable input/output signal corresponding to whether the component is currently enabled or disabled is also read. The controllable input/output signal is connected, through a multiplexer and a flip-flop, to an input of a switch controlling the visibility of the select line of the component at the bus.

Where the value stored in the non-volatile memory is not equal to the value of the controllable input/output signal, the value of the controllable input/output signal is set equal to the value of the non-volatile memory. The bus is then reset, to control the switch in accordance with the value of the non-volatile memory. In this way, enablement and disablement of the component of the computing device is controlled. Still other aspects and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a circuit for controlling the enablement and disablement of a computing device component, according to an embodiment of the invention, and is suggested for printing on the first page of the patent.

FIG. 2 is a diagram of a representative architecture of a representative computing device, according to an embodiment of the invention.

FIG. 3 is a diagram of a circuit for controlling the enablement and disablement of a computing device component, which is provided in more detail than but that is consistent with the circuit of FIG. 1, according to an embodiment of the invention.

FIG. 4 is a timing diagram showing the disablement of a computing device component, according to an embodiment of the invention.

FIG. 5 is a flowchart of a method for controlling the enablement and disablement of a computing device component, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Overview

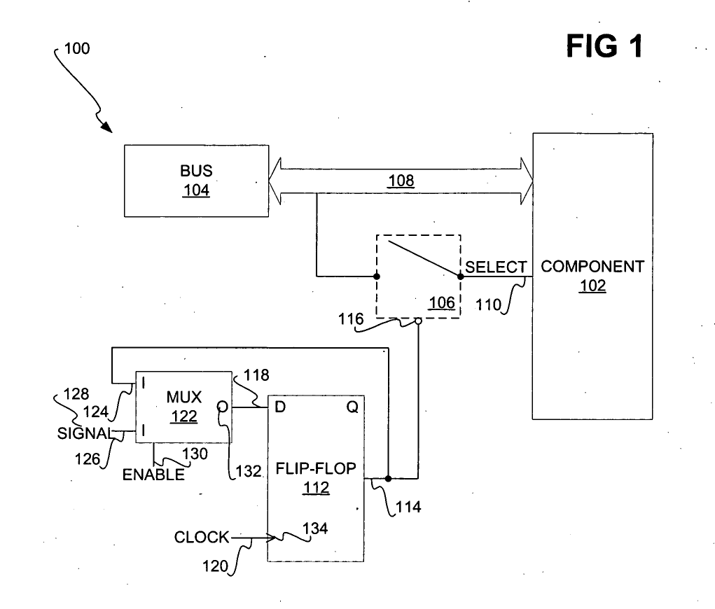

FIG. 1 shows a circuit 100 for controlling enablement and disablement of a component 102 of a computing device, according to an embodiment of the invention. The component 102 may be a wired network connectivity component or communication mechanism, to connect to wired networks, a wireless network connectivity component or communication mechanism, to connect to wireless networks, or another type of component or mechanism. Where the component 102 is a wireless network connectivity component, it may be a so-called 802.11a, 802.11b, and/or 802.11g wireless network connectivity components, among other types of wireless network connectivity components. The computing device is preferably a portable computer, such as a laptop or a notebook computer, but may also be a desktop computer, or another type of device.

The circuit 100 includes a switch 106, a flip-flop 112, and a two-way multiplexer 122, or mux. The component 102 generally has a plurality of lines 108 connecting the component 102 to a bus 104, such as a Peripheral Component Interconnect (PCI) bus, or another type of bus. However, a select line 110 has been separated from the lines 108. Rather, the switch 106 is situated on the select line 110, between the component 102 and the bus 104. The switch 106 controls whether the select line 110 is visible at the bus 104. Visibility of the select line 110 at the bus 104 determines whether the component 102 is enabled or disabled. For instance, if the switch 106 is open, the select line 110 is not connected to the bus 104, and is not visible at the bus 104, such that the component 102 is disabled. If the switch 106 is closed, the select line 110 is connected to the bus 104, and is visible at the bus 104, such that the component 102 is enabled.

The flip-flop 112 is a clocked D-type flip-flop, where a Q output 114 follows a D input 118 in accordance with a clock signal 120 on a clock line 134 of the flip-flop 112. The clock signal 120 may be the clock signal of or for the bus 104. The Q output 114 may, for instance, follow the D input 118 at the rising edge or at the falling edge of the clock signal 120 on the clock line 134. That the Q output 114 follows the D input 118 means that the Q output 114 is equal to the D input 118, no later than one clock signal after a signal has been asserted on the D input 118. Furthermore, the Q output 114 is connected to a not input 116 of the switch 106. This means that when the Q output 114 is high, or logic one, the switch 106 is turned off and is open, and when the Q output 114 is low, or logic zero, the switch 106 is turned on and is closed. The input 116 of the switch 106 may alternatively be an input other than a not input.

The two-way multiplexer 122 has an output 132 that is connected to the D input 118 of the flip-flop 112. The multiplexer 122 is a two-way multiplexer because it has two inputs, a first input 126 and a second input 126. Depending on the value of the enable line 130 of the multiplexer 122, either the first input 126 or the second input 124 is output on the output 132 for input to the D input 118 of the flip-flop 112. A controllable input/output signal 128 is asserted on the first input 126. The controllable input/output signal 128 is asserted, or set, in accordance whether the component 102 is to be enabled or disabled. When the signal 128 is low, or logic zero, the component 102 is enabled, whereas when the signal 128 is high, or logic one, the component 102 is disabled. Therefore, the signal 128 may be considered a component disable signal. The second input 124 is connected to the Q output 114 of the flip-flop 112. The enable line 130 may be the connected to the reset line of the bus 104.

The circuit 100 operates as follows. The controllable input/output signal 128 is asserted with a value corresponding to whether the component 102 is to be enabled or disabled. The enable line 130 is asserted high for at least one clock cycle of the clock signal 120. The output 132 of the multiplexer 122 becomes equal to the value of the signal 128, such that the D input 118 receives the value of the signal 128. The Q output 114 of the flip-flop 112 follows the D input 118, and hence the value of the signal 128, no later than one clock cycle of the clock signal 120 after the enable line 130 has been asserted high. The Q output 114 controls the switch 106, which becomes open or closed depending on the value of the signal 128. Therefore, visibility and invisibility of the component 102 at the bus 104, and hence enablement and disablement of the component 102, is controlled.

After at least one clock cycle of the clock signal 120, the enable line 130 reverts back to low. As such, the output 132 of the multiplexer 122 becomes equal to the input 124, which is tied to the Q output 114 of the flip-flop 112. Because the Q output 114 was already set equal to the value of the controllable input/output signal 128, this means that the output 132 of the multiplexer 122 remains the same after the enable line 130 reverts back to low. That is, once the enable line 130 reverts back to low, the signal 128 does not have to be asserted any longer with a value corresponding to whether the component 102 is to be enabled or disabled, because the input 124 ensures that the desired value is maintained at the flip-flop 112, and thus at the switch 106. In an alternative embodiment, the second input 124 may be connected to the output 132 of the multiplexer 122, instead of to the Q output 114 of the flip-flop 112.

In the embodiment where the enable line 130 is connected to the reset line of the bus 104, and/or where the clock signal 120 is the clock signal of or for the bus 104, visibility or invisibility of the component 102 at the bus 104 is maintained regardless of whether the bus 104 is inactive or active. That is, a change in visibility of the bus 104 can be accomplished in this embodiment only when the reset line of the bus 104 is asserted so that the signal 128 at the input 126 of the multiplexer 122 is output at the output 132 of the multiplexer 122. However, visibility or invisibility of the component 102 at the bus 104 is thereafter maintained, regardless of whether the bus 104 is inactive or active, due to the multiplexer 122 outputting the second input 124 at its output 132. That is, the multiplexer 122, in conjunction with the flip-flop 112, ensures the visibility or invisibility of the component 102 at the bus 104 is maintained regardless of whether the bus 104 is inactive or active.

Technical Background

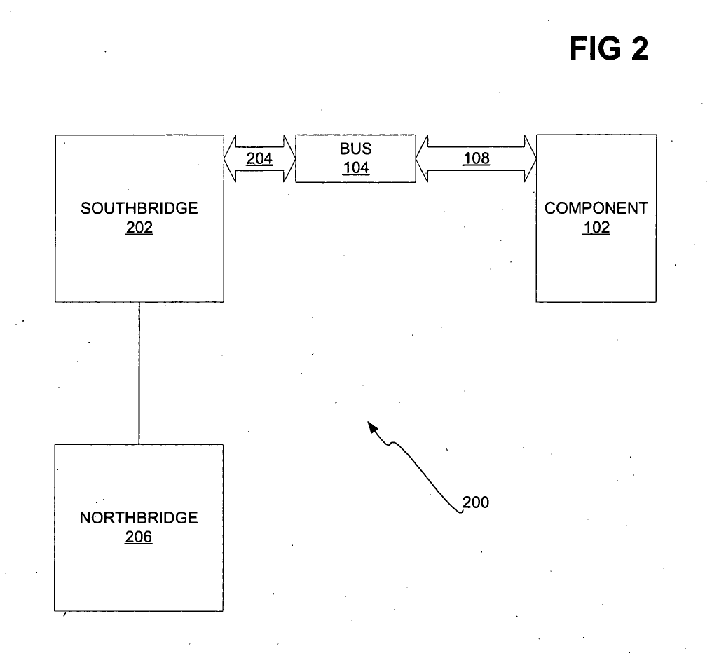

FIG. 2 shows a representative architecture of a computing device 200, according to an embodiment of the invention. The computing device 200 is depicted as having the component 102, the bus 104, a Southbridge controller 202, and a Northbridge controller 204. As can be appreciated by those of ordinary skill within the art, the computing device 200 may have other components, in addition to and/or in lieu of those depicted in FIG. 2. As has been indicated, the bus 104 may be a Peripheral Component Interconnect (PCI) in one embodiment of the invention. As has also been indicated, the component 102 may be a wired network connectivity component, to connect to wired networks, a wireless network connectivity component, to connect to wireless networks, or another type of component.

The component 102 is connected to the bus 104 via a plurality of lines 108. Likewise, the Southbridge controller 202 is connected to the bus 104 via a plurality of lines 308. The Southbridge controller 202 is, therefore, the controller that is able to communicate with the component 102, such as over the bus 104. The Southbridge controller 202 is communicatively connected to the Northbridge controller 206. The Northbridge controller 206 is the controller for a frontside bus (FSB), which can interface between processors, memory, and Accelerated Graphic Port (AGP) and PCI buses, none of which except for the PCI bus is particularly depicted in FIG. 2. The Northbridge controller 206 may further include a display controller, obviating the need for a separate display adapter.

By comparison, the Southbridge controller 202 is, effectively a PCI—Industry Standard Architecture (ISA) bridge that is connected to the Northbridge controller 206. The Southbridge controller 202 controls the rest of the input/output (I/O) of the computing device 200, such as Integrated Drive Electronics (IDE) drives, Universal Serial Bus (USB), serial and audio ports, and an Industry Standard Architecture (ISA) bus, none of which is particularly depicted in FIG. 2. The Southbridge controller 202 may also be referred to as the I/O controller hub. The architecture of the computing device 200 of FIG. 2 is depicted for example and representative purposes only, and other computing devices may employ architectures that do not include the Northbridge controller 206 and/or the Southbridge controller 204. That the architecture of the computing device 200 of FIG. 2 includes a Northbridge controller 206 and a Southbridge controller 204 means that the chipset architecture of the computing device 200 is such that it includes these two controllers.

Circuit and Method to Control Disablement and Enablement of Component

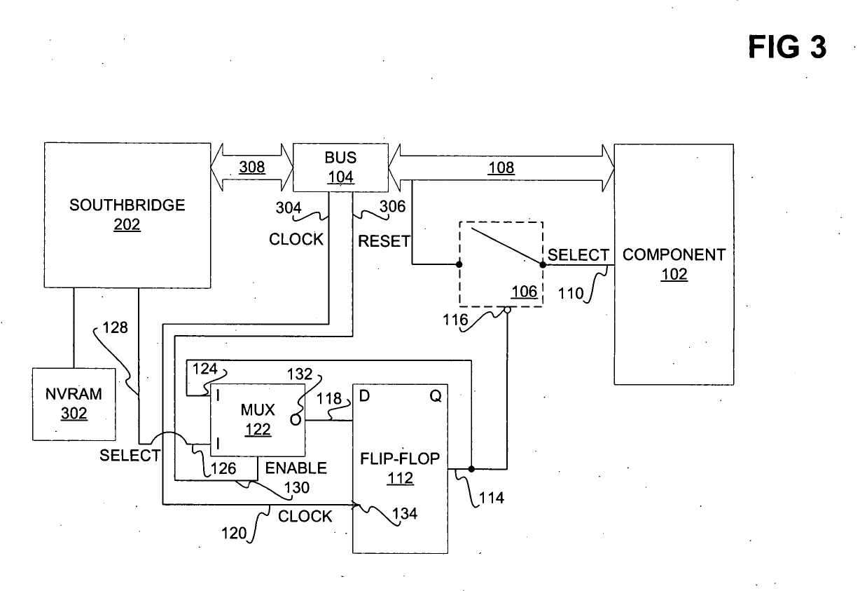

FIG. 3 shows the circuit 100 for controlling disablement and enablement of the component 102, as particularly implemented in relation to the computing device 200 of FIG. 2, according to an embodiment of the invention. The circuit 100 of the embodiment of FIG. 3 is more detailed than but consistent with the circuit 100 of the embodiment of FIG. 1. As before, the circuit 100 includes the switch 106, the flip-flop 112, and the two-way multiplexer 122, or mux, as well as a non-volatile memory 302, such as a non-volatile random-access memory (NVRAM).

The component 102 generally has the plurality of lines 108 connecting the component 102 to the bus 104, such as a Peripheral Component Interconnect (PCI) bus, or another type of bus. The select line 110 of the component 102 has been separated from the lines 108, and the switch 106 is situated on the select line 110 between the component 102 and the bus 104. The switch 106 controls whether the select line 110 is visible at the bus 104. Visibility of the select line 110 at the bus 104 determines whether the component 102 is enabled or disabled. If the switch 106 is open, the select line 110 is not connected to the bus 104, and the component 102 is disabled. If the switch 106 is closed, the select line 110 is connected to the bus 104, and the component 102 is enabled.

The flip-flop 112 is a clocked D-type flip-flop, where the Q output 114 follows the D input 118 in accordance with the clock signal 120 on the clock line 134 of the flip-flop 112. The clock signal 120 in the embodiment of FIG. 3 is specifically a clock signal of the clock line 304 of the bus 104. The Q output 114 in one embodiment follows the D input 118 at the rising edge of the clock signal 120 on the clock line 134. The Q output 114 is connected to the not input 116 of the switch 106. When the Q output 114 is high, or logic one, the switch 106 is turned off and is open, and when the Q output 114 is low, or logic zero, the switch 106 is turned on and is closed.

The output 132 of the two-way multiplexer 122 is connected to the D input 118 of the flip-flop 112. Depending on the value of the enable line 130 of the multiplexer 122, either the first input 126 or the second input 124 is output on the output 132 for input to the D input 118 of the flip-flop 112. The controllable input/output signal 128 is asserted on the first input 126 by the Southbridge controller 202 in the embodiment of FIG. 3, which stores the value to be asserted as the controllable input/output signal 128 in the non-volatile memory 302. That is, the controller 202 operably controls the value asserted on the input 126. The signal 128 may be a general-purpose input/output (GPIO) signal of the controller 202. The controllable input/output signal 128 is asserted or set according to whether the Southbridge controller 202 wishes to enable or disable the component 102. When the signal 128 is low, or logic zero, the component 102 is enabled, and when the signal 128 is high, or logic one, the component 102 is disabled. The second input 124 is connected to the Q output 114 of the flip-flop 112. The enable line 130 is connected to a reset signal of the reset line 306 of the bus 104 in the embodiment of FIG. 3.

As described in relation to the circuit 100 of the embodiment of FIG. 1, the circuit 100 of the embodiment of FIG. 3 is able to maintain visibility or invisibility of the component 102 at the bus 104 regardless of whether the bus 104 is inactive or active. Although the Southbridge controller 202 may not be able to control the bus 104 unless it is active, visibility or invisibility of the component 102 at the bus 104 is maintained due to the multiplexer 122 outputting the second input 124 at its output 132. That is, the multiplexer 122, in conjunction with the flip-flop 112, ensures the visibility or invisibility of the component 102 at the bus 104 is maintained regardless of whether the bus 104 is inactive or active.

Furthermore, the circuit 100 of the embodiment of FIG. 3 is able to maintain visibility or invisibility of the component 102 regardless of whether power has been removed from the computing device 200, and hence form the circuit 100. For instance, the flip-flop 112 may be non-volatile, such that its Q output 114 remains the same when power to the circuit 100 is removed. Additionally, or alternatively, the non-volatile memory 302 stores the value of the controllable input/output signal 128, so that when power is restored, the Southbridge controller 202 is able to assert the proper value of the signal 128 on the input 126 of the multiplexer 122.

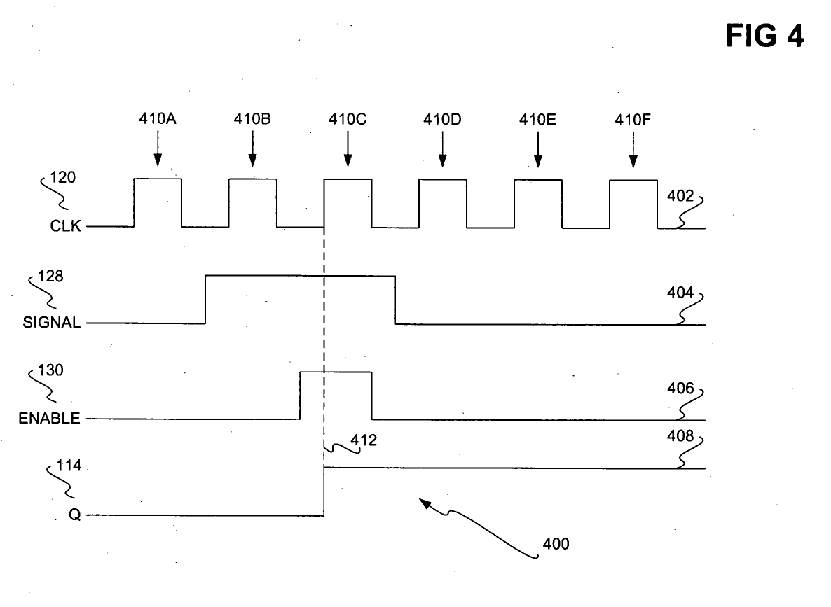

FIG. 4 shows a timing diagram 400 of an example execution of the circuit 100 of the embodiment of FIG. 3 to disable the component 102, according to an embodiment of the invention. The timings of four different signals, lines, and outputs are depicted in FIG. 4: the timing 402 of the clock signal 120, the timing 404 of the controllable input/output signal 128, the timing 406 of the enable line 130, and the timing 408 of the Q output 114 of the flip-flop 112. The timing diagram 400 of FIG. 4 assumes that the component 102 is currently enabled, in that the select line 110 is visible at the bus 104.

The clock signal 120 regularly asserts clock pulses, such as the pulses 410A, 410B, 410C, 410D, 410E, and 410F, collectively referred to as the clock pulses 410. The controllable input/output signal 128 is asserted high after the pulse 410A but before the clock pulse 410B. For instance, the Southbridge controller 202 may assert the signal 128 high at the input 126 of the multiplexer 122.

While the signal 128 remains high, or at logic one, the enable line 130 is asserted high, or at logic one, for at least one clock period or pulse, such as during the clock pulse 410C. For instance, the reset line 306 of the bus 104 may be asserted to reset the bus 104. This causes the multiplexer 122 to pass the high signal, or logic one, present at the input 126 to the output 132 of the multiplexer 122, which is connected to the D input 118 of the flip-flop 112.

At the rising edge of the clock pulse 410C, as indicated by the dotted line 412, the Q output 114 of the flip-flop 112 follows the high signal, or logic one, at the D input 118 of the flip-flop 112. Because the Q output 114 is connected to the not input 116 of the switch 106, the select line 110 of the component 102 is disconnected from the bus 104, and is no longer visible at the bus 104. As such, the component 102 becomes disabled as a result of the Southbridge controller 202 initially asserting the signal 128 high and the enable line 130 being asserted thereafter.

Once the component 102 has been disabled, the enable line 130 first can revert back to low, or logic zero, after the clock pulse 410C, and then the controllable input/output signal 128 can revert back to low, or logic zero. Preferably the signal 128 reverts back to low only after the enable line 130 has already reverted back to low. The enable line 130 reverting back to low selects the input 124 of the multiplexer 122 to pass through to the output 132 of the multiplexer 122, and be input at the D input 118 of the flip-flop 112. Since the input 124 is connected to the Q output 114 of the flip-flop 112, the enable line 130 reverting back to low maintains the Q output 114 of the flip-flop 112 in its current state, so that the signal 128 can revert back to low.

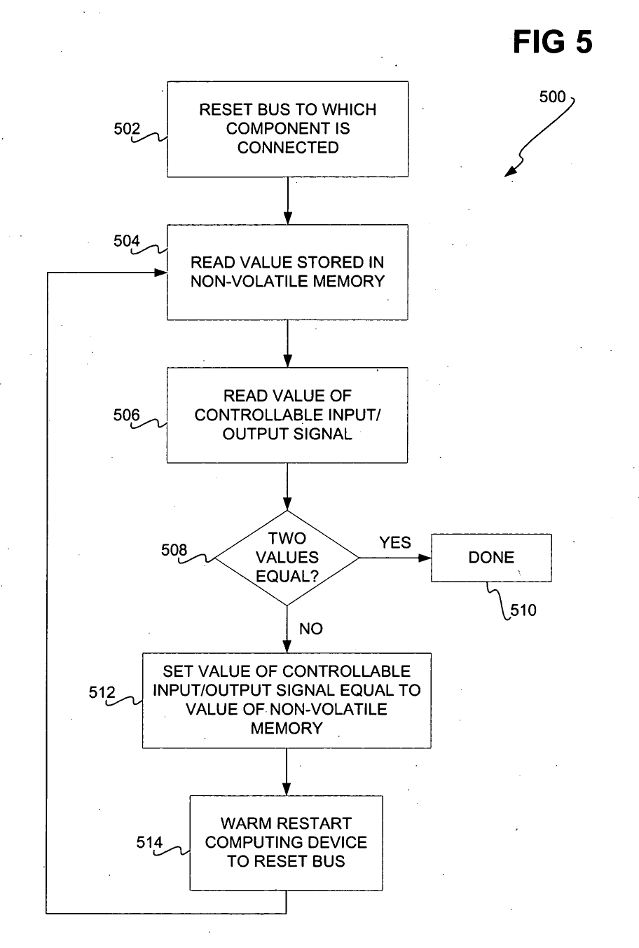

FIG. 5 shows a method 500 for controlling enablement and disablement of the computing device component 102, according to an embodiment of the invention. The method 500 may be performed in relation to the circuit 100 of FIGS. 1 and/or 3, and thus may be performed in relation to the computing device 200 of FIG. 2. As such, the method 500 is described in relation to the circuit 100 of FIG. 3 in particular, a timing diagram of which has already been described in relation to FIG. 4. Furthermore, the method 500 may be implemented as a computer program stored on and/or executed from a computer-readable medium of an article of manufacture. The medium may be a recordable data storage medium, a modulated carrier signal, or another type of medium.

First, the bus 104 to which the component 102 is connected is reset (502). The bus 104 may be reset by asserting the reset line 306 high, where the reset line 306 is communicatively connected to the enable line 130 of the multiplexer 122. The value stored in the non-volatile memory 302 is read by the Southbridge controller 202 (504). The Southbridge controller 202 also reads the value currently asserted on the controllable input/output signal 128 (506). If these two values are equal (508), then the method 500 is finished (510). That is, the method 500 concludes that the component 102 has already been enabled or disabled in accordance with the value stored in the non-volatile memory 302. Because the value of the signal 128 is equal to the value stored in the memory 302, and because the bus 104 has already been reset in 502, the value of the signal 128 has already caused the select line 110 to be connected to or disconnected from the bus 104 in accordance with both these values.

However, if the value currently asserted on the controllable input/output signal 128 is not equal to the value stored in the non-volatile memory 302 (508), then this means that the select line 110 has not been connected to or disconnected from the bus 104 in accordance with the value stored in the memory 302. Rather, the select line 110 has been connected to or disconnected from the bus 104 in accordance with the value of the signal 128. Therefore, the Southbridge controller 202 sets the value of the controllable input/output signal 128 equal to the value stored in the non-volatile memory 302 (512), and performs a warm reset of the computing device 200 to reset the bus 104 (514). Resetting the bus 104 causes the new value of the signal 128 to propagate through the multiplexer 122 and the flip-flop 112, such that the switch 106 is turned on or off in accordance with this value. The method 500 finally repeats beginning at 504 to verify that the reset operation has been performed correctly.

Advantages, Alternative Embodiments, and Conclusion

Embodiments of the invention provide for advantages over the prior art. Embodiments of the invention permit components, such as wired and wireless network connectivity components, to be disabled when desired, such as when preloading images including operating systems and desired application computer programs onto computing devices. Furthermore, unlike the prior art, embodiments of the invention allow components of portable computing devices, like laptop and notebook computers, to be disabled when desired.

Embodiments of the invention have been described primarily in relation to wired and wireless network connectivity components of laptop and notebook computers. However, other embodiments of the invention can be implemented in conjunction with types of components other than wired and wireless network connectivity components. Furthermore, other embodiments of the invention can be implemented in conjunction with types of computers other than portable computers.

It is therefore noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. It is manifestly intended that this invention be limited only by the claims and equivalents thereof.

We claim:

1. A circuit for controlling enablement and disablement of a component of a computing device, comprising:
a switch situated on a select line of the component between the component and a bus, the switch to control whether the select line of the component is visible at the bus, visibility of the select line at the bus determining whether the component is enabled or disabled;
a flip-flop having an output connected to an input of the switch; and,
a two-way multiplexer connected to an input of the flip-flop, a first input of the multiplexer connected to the output of the flip-flop, a second input of the multiplexer connected to a controllable input/output signal, an enable line of the multiplexer determining whether the first input or the second input is input to the flip-flop,
wherein the controllable input/output signal is set in accordance with whether the component of the computing device is to be enabled or disabled.

2. The circuit of claim 1, wherein the bus is a Peripheral Component Interconnect (PCI) bus.

3. The circuit of claim 1, wherein the flip-flop is a clocked flip-flop having a clock line.

4. The circuit of claim 3, wherein the clock line is connected to a clock signal of the bus.

5. The circuit of claim 1, wherein the controllable input/output signal is controlled by a controller.

6. The circuit of claim 5, wherein the controller is a Southbridge controller.

7. The circuit of claim 5, wherein the controller is able to control the controllable input/output signal only after the bus becomes active.

8. The circuit of claim 1, further comprising a non-volatile memory that is to store a desired value for the controllable input/output signal.

9. The circuit of claim 1, wherein the enable line of the multiplexer is connected to a reset line of the bus.

10. The circuit of claim 1, wherein the output of the flip-flop remains when power to the circuit is removed.

11. A computing device comprising:
a component having a select line;
a bus to which the select line of the component is connected; and,
a circuit situated on the select line of the component and connected between the component and the bus to control visibility of the select line at the bus regardless of whether power is removed from the computing device and regardless of whether the bus is inactive.

12. The computing device of claim 11, wherein the circuit comprises:
a switch situated on the select line of the component between the component and the bus, the switch to control whether the select line of component is visible at the bus, visibility of the select line at the bus determining whether the component is enabled or disabled;
a flip-flop having an output connected to an input of the switch;
a two-way multiplexer connected to an input of the flip-flop, a first input of the multiplexer connected to the output of the flip-flop, a second input of the multiplexer connected to a controllable input/output signal, an enable line of the multiplexer determining whether the first input or the second input is input to the flip-flop; and,
a non-volatile memory to store a desired value for the controllable input/output signal,
wherein the controllable input/output signal is set in accordance with whether the component of computing device is to be enabled or disabled.

13. The computing device of claim 12, further comprising a controller that operatively controls the controllable input/output signal based on the desired value stored by the non-volatile memory.

14. The computing device of claim 13, wherein the controller is a Southbridge controller, the computing device further comprising a chipset architecture including a Northbridge controller and the Southbridge controller.

15. The computing device of claim 11, wherein the component is at least one of: a wired network communication mechanism and a wireless network communication mechanism.

16. A computing device comprising:
a component having a select line;
a bus to which the select line of the component is connected; and,
means for controlling visibility of the select line at the bus regardless of whether power is removed from the computing device and regardless of whether the bus is inactive.

17. A method for controlling enablement and disablement of a component of a computing device comprising:
resetting a bus to which the component is connected, visibility of a select line of the component at the bus determining whether the component is enabled or disabled;
reading a value stored in a non-volatile memory corresponding to whether the component should be enabled or disabled;
reading a value of a controllable input/output signal corresponding to whether the component is currently enabled or disabled, the controllable input/output signal connected, through a multiplexer and a flip-flop, to an input of a switch controlling visibility of the select line of the component at the bus;
where the value stored in the non-volatile memory is unequal to the value of the controllable input/output signal,
setting the value of the controllable input/output signal equal to the value of the non-volatile memory and resetting the bus to control the switch in accordance with the value of the non-volatile memory.

18. The method of claim 17, wherein resetting the bus to control the switch in accordance with the value of the non-volatile memory comprises causing a warm restart of the computing device.

19. The method of claim 17, further comprising, where the value stored in the non-volatile memory is equal to the value of the controllable input/output signal, concluding that the component is enabled or disabled in accordance with the value stored in the non-volatile memory.

20. An article of manufacture comprising:
a computer-readable medium; and,
means in the medium for controlling visibility of a select line of a component of a computing device at a bus by controlling a switch situated on the select line of the component between the component and the bus in accordance with a value stored in a non-volatile memory.
